(19) United States
(12) Patent Application Publication
(10) Pub. No.: US 2016/0171402 A1
(43) Pub. Date: Jun. 16, 2016

(54) Determining an Investment Solution for at Least One Investment Area of A Region

(71) Applicants: Andreas Hapfelmeier, Munchen (DE); Stefan Hagen Weber, Munchen (DE)

(72) Inventors: Andreas Hapfelmeier, Munchen (DE); Stefan Hagen Weber, Munchen (DE)

(21) Appl. No.: 14/584,707

(22) Filed: Dec. 29, 2014

(30) Foreign Application Priority Data
Dec. 16, 2014 (EP) 14198223.1

(51) Int. Cl. G06Q 10/06

(52) U.S. Cl. CPC G06Q 10/06312

(57) ABSTRACT

A device is provided for determining an investment solution. The device includes a global unit being configured to: (1) send an investment indication on an investment amount to a plurality of local units, each local unit being associated with an investment area and being configured to determine a plurality of local investment solutions for the associated investment area based on the investment amount, (2) receive the plurality of local investment solutions from each local unit, and (3) determine a plurality of global solutions based on the received local investment solutions. The device also includes an optimization unit being configured to: (1) display the plurality of global solutions in a diagram together with associated investment effects, (2) receive a user input for adapting the diagram illustrating the plurality of global solutions, and (3) determine an investment solution from the plurality of global solutions based on the adapted diagram.

### CROSS-REFERENCE TO RELATED APPLICATIONS

This application claims the benefit of EP 14198223.1, filed on Dec. 16, 2014, which is hereby incorporated by reference in its entirety.

### TECHNICAL FIELD

The present embodiments relate to a device for determining an investment solution for at least one investment area of a region. Further, the present embodiments relate to a method for determining an investment solution for at least one investment area of a region.

### BACKGROUND

When planning investments within a region, for example, within a city, an optimization of the resources within the region may be required. In particular, new investments may be optimized as these new investments may have a high effect to the complete system of the region. An amount of investment may be defined for segments of the region, wherein an amount of investment may be defined for each segment based on local estimations of a demand being determined by experts for the different segments. Such segments or areas may be, for instance, water supply, energy supply, or traffic. The local estimations of demand are determined locally for each of the segments independent from the other segments as the experts know their own segment and have no, or at least little, knowledge about the other segments. Thus, the experts are not able to take into account effects on other segments or these effects are not obvious.

The decision maker, (e.g., a city manager or mayor that will decide which investments may be realized), receives the local estimations of a demand from the experts and then decides, using an available budget, how much of the budget is to spend to which segment. Global limits like costs, energy, or CO₂ emission are not taken into account, or at least only rudimentary. Further, a global overview of effects being caused by the investments of each segment is not provided. Thus, local investments or investment solutions may lead to global disadvantages and combinations of investments within different segments may be far away from a globally optimal solution.

### SUMMARY AND DESCRIPTION

The scope of the present invention is defined solely by the appended claims and is not affected to any degree by the statements within this summary. The present embodiments may obviate one or more of the drawbacks or limitations in the related art.

It is one object of the present embodiments to provide an improved way of determining investments to specific investment areas of a region.

According to a first aspect, a device for determining an investment solution for at least one investment area of a region is provided. The region includes a plurality of investment areas. The device includes a global unit being configured to: (1) send an investment indication on an investment amount to a plurality of local units, each local unit being associated with one investment area of the plurality of investment areas and being configured to determine a plurality of local investment solutions for the associated investment area based on the investment amount, (2) receive the plurality of local investment solutions from each of the plurality of local units, and (3) determine a plurality of global solutions based on the received local investment solutions. The device also includes an optimization unit being configured to: (1) display a visual representation of the plurality of global solutions in a diagram together with associated investment effects, (2) receive a user input for adapting the diagram illustrating the plurality of global solutions, and (3) determine an investment solution from the plurality of global solutions based on the adapted diagram.

The respective unit, (e.g., the global entity), may be implemented in hardware and/or in software. If the unit is implemented in hardware, the unit may be embodied as a device, (e.g., as a computer or as a processor or as a part of a system such as a computer system). If the unit is implemented in software, the unit may be embodied as a computer program product, as a function, as a routine, as a program code, or as an executable object.

The device is based on the idea to determine a global solution by taking into account separate local investment solutions and the effects of each of the local investment solutions, taken alone and/or in combination. A global solution in this context refers to an investment for one or more segments of a region, but in contrast to known approaches, under consideration of several segments or areas of the region.

The term “region” in this context refers to a geographical region such as a city or village. The extent of the region may vary and is not limited.

The term “investment area” in this context refers to segments of the region for which investments may be made. Such segments or areas may be for example water supply, energy supply, traffic (including road construction), and further areas. These segments may also be called verticals.

The global unit sends information of an available amount of investment as the investment indication to the plurality of local units. The amount of investment defines the monetary value being available for all investments within the region. Each of the local units is responsible for one investment area and determines possible investment solutions for the respective investment area. An investment solution may require the whole amount of investment or only a part of it. Further, an investment solution is associated with specific investment effects. Such investment effects may be positive or negative effects that will occur when implementing the corresponding investment solution. The investment effects may include, for example, return on investment, CO₂ emission (reduction or increase), and required energy (reduction or increase).

The global unit may determine a plurality of global solutions based on the plurality of local investment solutions from each local unit. A global solution may include investments to one or more investment areas.

The optimization unit displays the visual representation of the plurality of global solutions. This may be done for example in the form of a heatmap. The representation may include the global solutions itself, but also the investments effects being associated with the respective solution. The optimization unit represents a component to enable the user to compare the different possible solutions.

A user may adapt, via a user input, the diagram including the global solutions. The adaptation may be a subjective adaption based on personal preferences. The adaption may also be based on objective considerations like a maximum amount of investment or activities being associated with specific investment solutions that may or may not be required. Further, the adaptation may be performed iteratively, e.g., the user may approach the subjectively optimal solution act by act.

The optimization unit may select one global solution out of the plurality of global solutions as the investment solution to be implemented. The selection may be based on the adapted diagram and may be performed via a user input.

According to an embodiment, the global unit is configured to send a selection of investment areas to the local units, wherein the local units are configured to determine local investment solutions for the selection of investment areas.

According to this embodiment, the local investment solutions are only determined for selected investment areas. This selection may be input by a user before sending the information indicative for the amount of investment to the local units. The local units thus only determine local investment solutions for the selected investment areas. In one embodiment, the information indicative for the amount of investment is only send to the local units being associated with the selected investment areas.

According to a further embodiment, the global unit is configured to send a maximum number of local investment solutions to be determined by the local units.

The number of local investment solutions to be determined by each of the local units may be limited. The local units determine, as a maximum of solutions, the maximum number of local investment solutions. Also a smaller number than the maximum number of local investment solutions is possible.

According to a further embodiment, each of the plurality of local investment solutions includes the required amount of investment, the effects being associated with the local investment solutions, and activities being required when implementing the local investment solution.

Each of the local investment solutions being sent to the global unit includes the required amount of investment, e.g., the amount of investment needed to implement the proposed solution. Further, each of the local investment solutions includes the associated effects, e.g., advantages and disadvantages being associated with the proposed solution. Further, each of the local investment solutions includes activities or measures to be performed for implementing the proposed solution. Such activities or measures may be, for instance, new pipes, new roads, new power plants, or the like.

According to a further embodiment, the global unit is configured to determine the plurality of global solutions by combining the received local investment solutions.

Each of the plurality of global solutions may be a different combination of local investment solutions. Each global solution may include at the maximum one local solution per investment area. For example, one global solution may contain one local solution for each investment area. Another global solution may contain one local solution for some investment areas and no local solution for the rest of the investment areas.

According to a further embodiment, the global unit is configured to eliminate invalid combinations of local investment solutions.

It may be that some local solutions are mutually exclusive. The global solutions therefore do not include such mutually excluding local solutions.

According to a further embodiment, the global unit is configured, when combining the received local investment solutions, to provide all possible combinations over the plurality of investment areas.

According to this embodiment, all possible combinations are created over all investment areas of the investment areas. This spans a solution space of (X+1) combinations, wherein X denotes the number of local investment solutions per investment area, and wherein (X+1) is provided, as it is also possible to not invest in one of the investment areas.

According to a further embodiment, the global unit is configured to aggregate local investment effects being associated with each of the local investment solutions for each of the plurality of global solutions.

This provides that one global solution may have a plurality of investment effects as each of the local investment solutions has its own local investment effects. Some of the investment effects may also compensate each other.

According to a further embodiment, the global unit is configured, when aggregating the investment effects, to normalize the local investment effects and to weight the local investment effects based on a user input.

When determining which global solution is the optimal solution, the user may weight the different local investment effects. For example, the costs, (e.g., the amount of investment), may be important and will therefore get a high weight. CO₂ reduction may be less important and will therefore get a low weight. Other weights and other effects may also be used. Based on this weighting, the diagram illustrating the possible global solutions may be adapted.

According to a further embodiment, the optimization unit is configured to display for each global solution of the plurality of global solutions the real required amount of investment.

As a further decision criterion for finding the optimal solution, the real required amount of investment may be displayed. The real required amount of investment may be less than the available amount of investment.

In one embodiment, the user may input a minimum value for the amount of investment, (e.g., a minimum amount that may be used for the investments), and/or a maximum value for the amount of investment, (e.g., a maximum amount that may be used for the investments). The maximum amount may be higher than the investment amount.

According to a further embodiment, the optimization unit is configured to perform for each of the plurality of global solutions a correlation analysis for displaying at least two dimensions in the diagram.

For example, three dimensions may be depicted together in a heatmap or a scatter plot. This may be, for instance, x=CO₂ reduction, y=costs, and value=return on investment (ROI).

According to a further embodiment, the optimization unit is configured to apply a filter to provide filtered global solutions based on a user input.

For example, different effects may be filtered. For example, specific effects may not occur at all or only over or below a specified threshold. Further, specific activities may be filtered, (e.g., may be excluded or included).

According to a further embodiment, the optimization unit is configured to adapt the diagram based on the filtered global solutions.

The filter acts may reduce the number of possible global solutions. Thus, the diagram may be adapted accordingly and may illustrate only the remaining possible global solutions.

According to a further embodiment, the filter includes at least one of an investment effect, an activity being required when implementing the local investment solution, and a location of an activity being required when implementing the local investment solution.

The filter may also include any further limitations, such as the required amount of investment or the like.

Any embodiment of the first aspect may be combined with any embodiment of the first aspect to obtain another embodiment of the first aspect.

According to a second aspect, a method for determining an investment solution for at least one investment area of a region is provided, the region including a plurality of investment areas. The method includes the following acts: (1) sending an investment indication on an investment amount to a plurality of local units, each local unit being associated with one investment area of the plurality of investment areas and being configured to determine a plurality of local investment solutions for the associated investment area based on the investment indication; (2) receiving the plurality of local investment solutions from each of the plurality of local units; (3) determining a plurality of global solutions based on the received local investment solutions; (4) displaying a visual representation of the plurality of global solutions in a diagram together with associated effects; (5) receiving a user input for adapting the diagram illustrating the plurality of global solutions; and (6) determining an investment solution from the plurality of global solutions based on the adapted diagram.

According to a further aspect, a computer program product includes a program code for executing the above-described method for determining an investment solution for at least one investment area of a region when run on at least one computer.

A computer program product may be embodied as a memory card, USB stick, CD-ROM, DVD, or as a file, which may be downloaded from a server in a network. For example, such a file may be provided by transferring the file including the computer program product from a wireless communication network.

The embodiments and features described with reference to the device apply to the method as well, changing those things that need to be changed.

Further possible implementations or alternative solutions also encompass combinations, which are not explicitly mentioned herein, of features described above or below with regard to the embodiments.

### BRIEF DESCRIPTION OF THE DRAWINGS

FIG. 1 depicts a schematic block diagram of an embodiment of a device for determining an investment solution for at least one investment area of a region.

FIG. 2 depicts an embodiment of a visual representation of the plurality of global solutions.

FIG. 3 depicts an embodiment of a sequence of method acts for determining an investment solution for at least one investment area of a region.

In the figures, like reference numerals designate like or functionally equivalent elements, unless otherwise indicated.

### DETAILED DESCRIPTION

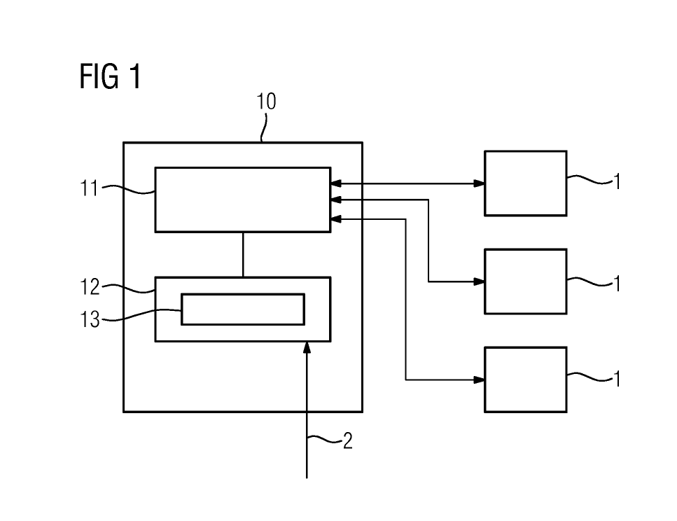

FIG. 1 depicts a device 10 for determining an investment solution for at least one investment area of a region.

The device 10 includes a global unit 11 and an optimization unit 12. The global unit 11 sends an investment indication to a plurality of local units 1. Without loss of generality, FIG. 1 depicts three local units 1. The investment indication indicates which amount of investment may be used for an investment. Each local unit 1 is associated with one investment area of the plurality of investment areas.

Each of the local units 1 determines a plurality of local investment solutions for the associated investment area based on the investment indication. Thus, each local investment solution includes an investment to the associated investment area that requires at maximum the amount of investment indicated by the investment indication.

The global unit 11 receives the plurality of local investment solutions from each of the plurality of local units 11 and determines a plurality of global solutions based on the received local investment solutions.

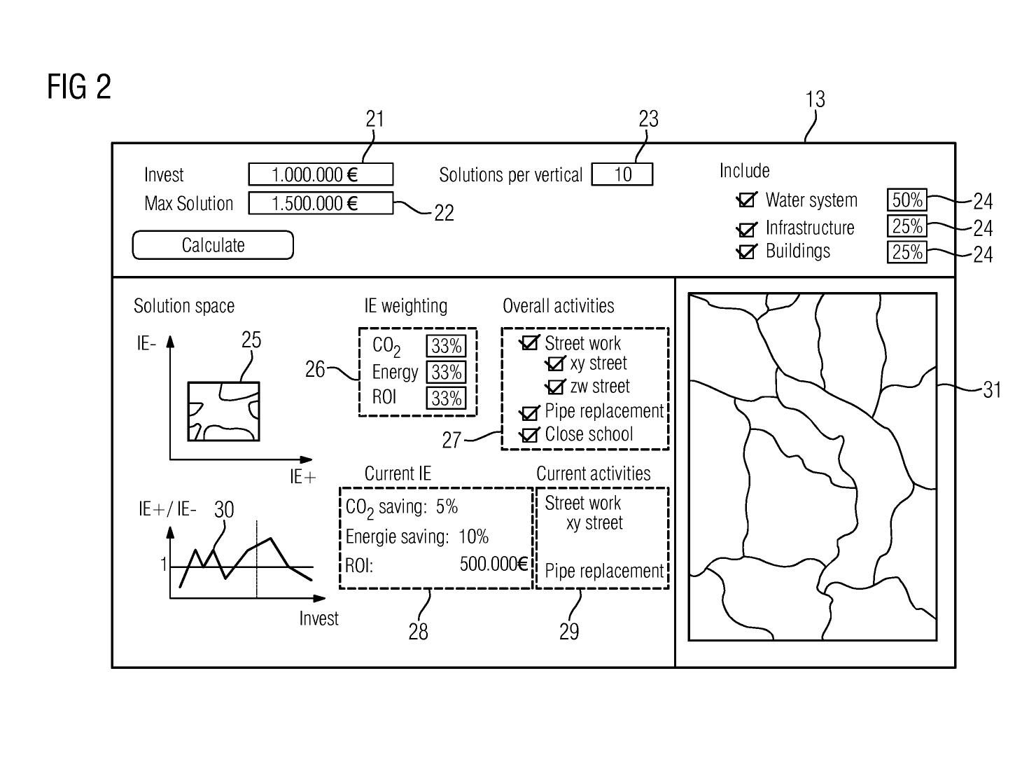

The optimization unit 12 displays a visual representation 13 of the plurality of global solutions in a diagram together with associated investment effects. An embodiment of the visual representation is depicted in FIG. 2.

The optimization unit 12 may receive a user input 2 and may adapt the diagram illustrating the plurality of global solutions based on the user input 2. Finally, the optimization unit 12 determines an investment solution from the plurality of global solutions based on the adapted diagram.

FIG. 2 depicts an embodiment of a visual representation 13.

The visual representation may, for example, include the initial information for determining the local investment solutions, such as an amount of investment 21, a maximum amount of investment 22, and/or a number 23 of solutions per investment area. Further, the user may select the investment areas 24 for which local investment solutions may be determined. After inputting this initial information, the user may start the calculation procedure.

After the described procedure for determining global solutions, the visual representation 13 may include an overview over the plurality of global solutions, (e.g., the number of solutions, a range of values, and a distribution of the values of the dimensions). This may be depicted, for example, in a heat map 25, where the positive and negative investment effects are depicted on the x and y axis and the values represent the global solutions.

Another diagram 30 may illustrate a ratio of the positive and negative investment effects on the x axis and the needed amount of investment on the y axis.

The measures or activities needed for the global solutions may be depicted in a map 31 by georeferencing. Thus, the user may determine solutions that need measures or activities at non-preferred places.

Further, the visual representation 13 may include a weighting 26 of different investment effects, like CO₂ emission, needed energy, and return on investment. Also the current values 28 of these investment effects may be depicted.

Also the overall activities 27, which are needed for the global solutions, may be selected by the user. Thus, if one activity is de-selected, the provided global solutions will not require this activity. The activities that are currently needed may also be depicted 29.

It may be noted that the visual representation 13 of FIG. 2 is only one example and other representations may be used or only parts of the depicted representation 13 or the visual representation 13 may include more than the depicted components.

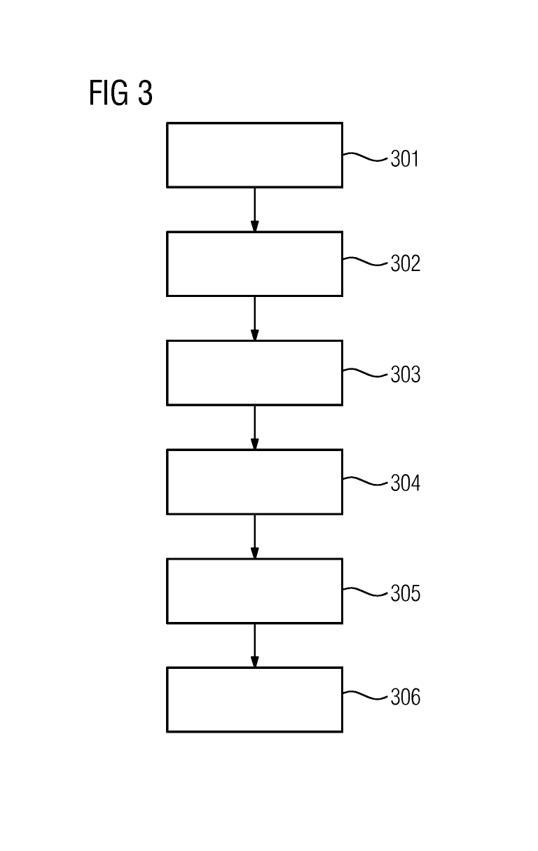

FIG. 3 depicts a sequence of method acts 301 to 308 for determining an investment solution for at least one investment area of a region.

In act 301, an investment indication on an investment amount is sent to a plurality of local units 1, each local unit 1 being associated with one investment area of the plurality of investment areas and being configured to determine a plurality of local investment solutions for the associated investment area based on the investment indication.

In act 302, the plurality of local investment solutions is received by the global unit 11 from each of the plurality of local units 1.

In act 303, a plurality of global solutions is determined based on the received local investment solutions.

In act 304, a visual representation 13 of the plurality of global solutions is displayed in a diagram together with associated effects.

In act 305, a user input 2 is received for adapting the diagram illustrating the plurality of global solutions.

In act 306, an investment solution is determined from the plurality of global solutions based on the adapted diagram.

The instructions for implementing processes or methods described herein may be provided on non-transitory computer-readable storage media or memories, such as a cache, buffer, RAM, FLASH, removable media, hard drive, or other computer readable storage media. A processor performs or executes the instructions to train and/or apply a trained model for controlling a system. Computer readable storage media include various types of volatile and non-volatile storage media. The functions, acts, or tasks illustrated in the figures or described herein may be executed in response to one or more sets of instructions stored in or on computer readable storage media. The functions, acts or tasks may be independent of the particular type of instruction set, storage media, processor or processing strategy and may be performed by software, hardware, integrated circuits, firmware, micro code and the like, operating alone or in combination. Likewise, processing strategies may include multiprocessing, multitasking, parallel processing and the like.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A device for determining an investment solution for at least one investment area of a region, the region having a plurality of investment areas, the device comprising:
a global unit configured to:
send an investment indication on an investment amount to a plurality of local units, wherein each local unit of the plurality of local units is associated with one investment area of the plurality of investment areas, and wherein each local unit of the plurality of local units is configured to determine a plurality of local investment solutions for the associated investment area based on the investment indication;
receive the plurality of local investment solutions from each local unit of the plurality of local units; and
determine a plurality of global solutions based on the received local investment solutions; and
an optimization unit configured to:
display a visual representation of the plurality of global solutions in a diagram together with associated investment effects;
receive a user input for adapting the diagram illustrating the plurality of global solutions; and
determine an investment solution from the plurality of global solutions based on the adapted diagram.

2. The device as claimed in claim 1, wherein the global unit is configured to send a selection of investment areas to the plurality of local units, and wherein the plurality of local units are configured to determine local investment solutions for the selection of investment areas.

3. The device as claimed in claim 2, wherein the global unit is configured to send a maximum number of local investment solutions to be determined by the plurality of local units.

4. The device as claimed in claim 3, wherein each local investment solution of the plurality of local investment solutions comprises a required amount of investment, effects being associated with the plurality of local investment solutions, and activities being required when implementing the local investment solution.

5. The device as claimed in claim 1, wherein the global unit is configured to send a maximum number of local investment solutions to be determined by the plurality of local units.

6. The device as claimed in claim 1, wherein each local investment solution of the plurality of local investment solutions comprises a required amount of investment, effects being associated with the plurality of local investment solutions, and activities being required when implementing the local investment solution.

7. The device as claimed in claim 1, wherein the global unit is configured to determine the plurality of global solutions by combining the received local investment solutions.

8. The device as claimed in claim 7, wherein the global unit is configured to eliminate invalid combinations of the received local investment solutions.

9. The device as claimed in claim 8, wherein the global unit is configured, when combining the received local investment solutions, to provide all possible combinations over the plurality of investment areas.

10. The device as claimed in claim 9, wherein the global unit is configured to aggregate local investment effects being associated with each local investment solution of the received local investment solutions for each global solution of the plurality of global solutions.

11. The device as claimed in claim 7, wherein the global unit is configured, when combining the received local investment solutions, to provide all possible combinations over the plurality of investment areas.

12. The device as claimed in claim 7, wherein the global unit is configured to aggregate local investment effects being associated with each local investment solution of the received local investment solutions for each global solution of the plurality of global solutions.

13. The device as claimed in claim 12, wherein the global unit is configured, when aggregating the investment effects, to normalize the local investment effects and to weight the local investment effects based on a user input.

14. The device as claimed in claim 1, wherein the optimization unit is configured to display, for each global solution of the plurality of global solutions, a real required amount of investment.

15. The device as claimed in claim 1, wherein the optimization unit is configured to perform for each global solution of the plurality of global solutions a correlation analysis for displaying at least two dimensions in the diagram.

16. The device as claimed in claim 1, wherein the optimization unit is configured to apply a filter to provide filtered global solutions based on a user input.

17. The device as claimed in claim 16, wherein the optimization unit is configured to adapt the diagram based on the filtered global solutions.

18. The device as claimed in claim 17, wherein the filter comprises at least one of: (1) an investment effect, (2) an activity being required when implementing the local investment solution, or (3) a location of an activity being required when implementing the local investment solution.

19. The device as claimed in claim 16, wherein the filter comprises at least one of: (1) an investment effect, (2) an activity being required when implementing the local investment solution, or (3) a location of an activity being required when implementing the local investment solution.

20. A method for determining an investment solution for at least one investment area of a region, the region having a plurality of investment areas, the method comprising:
sending an investment indication on an investment amount to a plurality of local units, each local unit of the plurality of local units being associated with one investment area of the plurality of investment areas and being configured to determine a plurality of local investment solutions for the associated investment area based on the investment indication;
receiving the plurality of local investment solutions from each local unit of the plurality of local units;
determining a plurality of global solutions based on the received local investment solutions;
displaying a visual representation of the plurality of global solutions in a diagram together with associated effects;
receiving a user input for adapting the diagram illustrating the plurality of global solutions; and
determining an investment solution from the plurality of global solutions based on the adapted diagram.
